(19) United States
(12) Patent Application Publication
(10) Pub. No.: US 2012/0009089 A1
(43) Pub. Date: Jan. 12, 2012

(54) THIN-FILM HIGH-ACTIVITY GAS SENSOR USING CORE-SHELL STRUCTURED COMPOSITE NANOPARTICLES AS SENSING MATERIAL AND METHOD OF MANUFACTURING THE SAME

(75) Inventor: Yeon Tae Yu, Jeonju (KR)

(73) Assignees: INDUSTRIAL COOPERATION FOUNDATION CHONBUK NATIONAL UNIVERSITY, Jeonju (KR); Yeon Tae YU, Jeonju (KR)

(21) Appl. No.: 12/988,198

(22) PCT Filed: Jul. 21, 2009
(86) PCT No.: PCT/KR2009/004016

§ 371 Date: Oct. 15, 2010

(30) Foreign Application Priority Data
Mar. 31, 2009 (KR) 10-2009-0027331

(51) Int. Cl. G01N 27/00; B05D 5/12

(52) U.S. Cl. 422/98; 427/97.3

(57) ABSTRACT

Disclosed herein is a thin-film high-activity gas sensor, the sensitivity, selectivity and long-term stability of which can be greatly improved, the manufacturing process of which can be simplified, and which can be formed into a thin film and be miniaturized.

### TECHNICAL FIELD

The present invention relates to a thin-film high-activity gas sensor and a method of manufacturing the same. Particularly, the present invention relates to a thin film high-activity gas sensor using core-shell structured composite nanoparticles as a sensing material, which can improve sensitivity, selectivity and long-term stability, which can be manufactured in the form of a thin film, which can be miniaturized and the manufacturing process of which can be simplified, and to a method of manufacturing the same.

### BACKGROUND ART

Generally, a thin-film high-activity gas sensor is characterized in that the electroconductivity thereof changes in a predetermined temperature range when gas is adsorbed on the surface thereof. Due to the change in electroconductivity, electron migration is caused between gas and a sensor material, and the electroconductivity thereof is increased or decreased depending on the properties of a semiconductor material. This electrical change is applied to an electric circuit, thus constituting a gas sensor. Further, such a thin-film high-activity gas sensor is characterized in that it is cheap and has rapid response characteristics. SnO₂, TiO₂, ZnO, ZrO₂, WO₃, In₂O₃, V₂O₅ or the like is used as a sensing material for semiconductor gas sensors.

Semiconductor gas sensors are classified into thin-film semiconductor gas sensors and thick-film semiconductor gas sensors depending on the method of fabrication of a sensing material. Thin-film semiconductor gas sensors are disadvantageous in that they are manufactured through a chemical deposition method or a physical deposition method, so that they have a smaller specific surface area than thick-film semiconductor gas sensors, with the result that their sensitivity is deteriorated. Therefore, thick-film semiconductor gas sensors are being employed as commercially-available semiconductor gas sensors.

Generally, a sensor chip used in a thick-film semiconductor gas sensor includes an alumina circuit board, electrodes, a sensing material (semiconductor) thick film and a heater, and is operated by a heater at a temperature of 300˜500° C. according to the properties of a sensing material. The performance of a thick-film semiconductor gas sensor greatly depends on the specific surface area or particle size of a sensing material.

FIG. 1 is a flowchart showing a conventional process of manufacturing a thick-film high-activity gas sensor.

Hereinafter, a conventional process of manufacturing a thick-film high-activity gas sensor will be described with reference to FIG. 1. First, a semiconductor sensing material is synthesized using various compound conductors in liquid phase, washed, filtered and then dried to obtain pure oxide powder.

This oxide powder is required to be crushed because it is dried and then agglomerated. Particularly, pulverizing and classifying processes are required in order to obtain oxide powder having a particle size necessary for various gas sensors. Generally, oxide powder having a particle size of 0.5˜2.0 μm is frequently used in semiconductor sensors. Oxide powder must be supported with a precious metal catalyst in order to improve the sensitivity of a sensing material, and this process is also generally performed in an aqueous precious metal compound solution. Therefore, even after oxide powder is supported with a precious metal catalyst, it must be washed, filtered and then dried. In order to use oxide powder supported with a precious metal catalyst as a sensing material for detecting gas, it must be applied onto an alumina substrate provided with electrode circuits, and, currently, a screen printing method is being commercially used to apply the oxide powder onto the alumina substrate. Therefore, the oxide powder supported with the precious metal catalyst must be made into paste by mixing the oxide powder with an organic binder. In this process, SiO₂ particles having a high melting point may be mixed therewith in order to prevent the increase in the specific surface area of a sensing material caused by the increase in the particle size thereof in a process of sintering a semiconductor material. The obtained oxide powder paste is applied onto the alumina substrate through a screen printing process, and is sintered and attached on the alumina substrate through a heat treatment process. The sintering of the oxide powder paste is performed at a high temperature of 700˜1000° C. although tempering temperature is changed depending on the kind of materials.

In a gas sensor, the sensitivity of the gas sensor greatly depends on the specific surface area thereof because the sensing reaction between the gas sensor and target gas is generally a surface reaction. Particularly, in the case of a semiconductor gas sensor, the particle size of a semiconductor sensing material may be smaller in order to improve the sensitivity thereof because target gas is detected and its concentration change is measured by monitoring the change in electroconductivity or electric resistance between the target gas and sensing material occurring when electrons are donated and accepted therebetween.

FIG. 2 is a view for explaining a principle of a SnO₂ gas sensor. Hereinafter, the correlation between the particle size and sensitivity of a semiconductor sensing material will be described with reference to FIG. 2. In this description, SnO₂, which is mostly used as a sensing material of a thin-film high-activity gas sensor, reacts with carbon monoxide (CO).

When SnO₂ is heated to a temperature of 300˜400° C. in the atmosphere, thermal energy is applied to SnO₂, and thus electrons increase therein. When oxygen (O₂) is adsorbed thereon, the oxygen (O₂) captures the electrons included in the SnO₂, and is thus changed to O⁻. For this reason, as shown in FIG. 2, electron depletion layers are formed on the surfaces of SnO₂ particles, thus raising the potential barrier of SnO₂ and decreasing the electroconductivity thereof. When reducing gas or inflammable gas is present around SnO₂, since this gas is oxidized by oxygen, free electrons captured in the oxygen (O₂) return into SnO₂ particles, so that the potential barrier of SnO₂ is lowered, thereby increasing the electroconductivity thereof. In conclusion, the sensitivity of a gas sensor depends on the adsorptivity and desorptivity of oxygen (O₂), and, basically, the specific surface area of SnO₂ powder must be increased in order to increase the adsorptivity of oxygen (O₂).

FIG. 3 shows the change in resistance of a gas sensor according to the particle size of SnO₂. From FIG. 3, it can be seen that, since the electric resistance of SnO₂ having a particle size of 6 nm or less and including only electron depletions layer is greatly increased, the particle size of SnO₂ is required to be decreased in order to improve the sensitivity of SnO₂.

As described above, in order to improve the gas sensing ability of a semiconductor metal oxide, it is required that nanosized sensing materials be prepared.

Nevertheless, the reason why metal oxide powder having a particle size of 0.5˜2.0 μm is used in conventional commercial technologies is that metal oxide powder becomes coarse during a high-temperature heat treatment process. In order to prevent the coarsening of metal oxide powder during the heat treatment process, SiO₂ fine powder having a high melting point is added to the metal oxide powder. However, when an excess of SiO₂ fine powder is added thereto, the gas adsorptivity of a sensing material is decreased and the electrical resistance thereof is increased, thus deteriorating the gas sensing properties of a gas sensor.

Further, since it is difficult to ensure stability using only a semiconductor sensing material, the semiconductor sensing material is supported with a precious metal catalyst, such as Pt, Pd or the like, and then used in order to improve the sensitivity thereof and to lower the operation temperature thereof. However, the addition of the precious metal catalyst is advantageous in that the operation temperature of the semiconductor sensing material is lowered and the sensitivity thereof is improved, but is problematic in that the gas selectivity thereof is deteriorated. That is, since the reaction rate of the semiconductor sensing material to all gases is accelerated, the semiconductor sensing material rapidly reacts even with any gas, with the result that the gas selectivity thereof is deteriorated. Therefore, such a problem may be a cause of malfunction of a gas sensor.

A gas sensor using a semiconductor metal oxide is very advantageous in that it is cheap, but is disadvantageous in that it is required to develop a new economical process of more simply manufacturing the gas sensor because this sensor inevitably competes with different types of gas sensors. The conventional process of manufacturing a thick-film high-activity gas sensor is complicated compared to the present invention because it includes the steps of synthesizing metal oxide powder and post-treating the metal oxide powder, making the metal oxide into metal oxide powder paste and applying the metal oxide powder paste onto a substrate through a screen printing process. Further, recently, the development of smart sensors has attracted considerable attention, and thus technologies for combining or miniaturizing sensors have been keenly required. However, the screen printing technology, which is employed in the conventional gas sensor manufacturing method, is limited in the miniaturization of sensors.

### DISCLOSURE

### Technical Problem

Accordingly, the present invention has been made to solve the above-mentioned problems, and an object of the present invention is to provide a thin film high-activity gas sensor using core-shell structured composite nanoparticles as a sensing material, which can improve sensitivity, selectivity and long-term stability, which can be manufactured in the form of a thin film, which can be miniaturized, and the manufacturing process of which can be simplified, and to provide a method of manufacturing the same.

### Technical Solution

In order to accomplish the above object, an aspect of the present invention provides a thin-film high-activity gas sensor using a core-shell structured composite nanoparticle as a sensing material, the composite nanoparticle including a core and a shell covering the core.

In the gas sensor, the core may be made of metal nanoparticles having excellent electroconductivity and antioxidant properties, preferably one or more selected from among Au, Ag, Pt, Pd, Ir and Rh.

Further, the shell may be made of metal oxide nanoparticles having semiconductivity, preferably one or more selected from among TiO₂, SnO₂, ZnO, ZrO₂, WO₃, In₂O₃, V₂O₅ and RuO.

Another aspect of the present invention provides a method of manufacturing a thin-film high-activity gas sensor, including: applying a composite nanoparticle including a metal nanoparticle core and a metal oxide nanoparticle shell covering the metal nanoparticle core onto an electrode circuit substrate.

In the method, the composite nanoparticle may be applied onto the electrode circuit substrate using any one selected from among a drop coating method, a dip coating method, a spin coating method and an ink-jet printing method to form a thin film.

### Advantageous Effects

The thin-film high-activity gas sensor according to the present invention is advantageous in that a sensing material can be really made into nanoparticles and in that the sensitivity, selectivity and long-term stability thereof can be greatly improved.

Further, the thin-film high-activity gas sensor according to the present invention is advantageous in that its manufacturing process can be simplified because metal oxide is not required to be pulverized, classified and made into paste, thus greatly improving productivity, and in that it can be manufactured in the form of a thin film and can be miniaturized.

Furthermore, the thin-film high-activity according to the present invention is advantageous in that its sensitivity is improved due to the increase in activity, so that its operation temperature can be lowered, with the result that its drive power can be reduced and its stabilization time at the time of an initial operation can be greatly decreased.

### DESCRIPTION OF DRAWINGS

The above and other objects, features and advantages of the present invention will be more clearly understood from the following detailed description taken in conjunction with the accompanying drawings, in which:

FIG. 1 is a flowchart showing a conventional process of manufacturing a thick-film high-activity gas sensor;

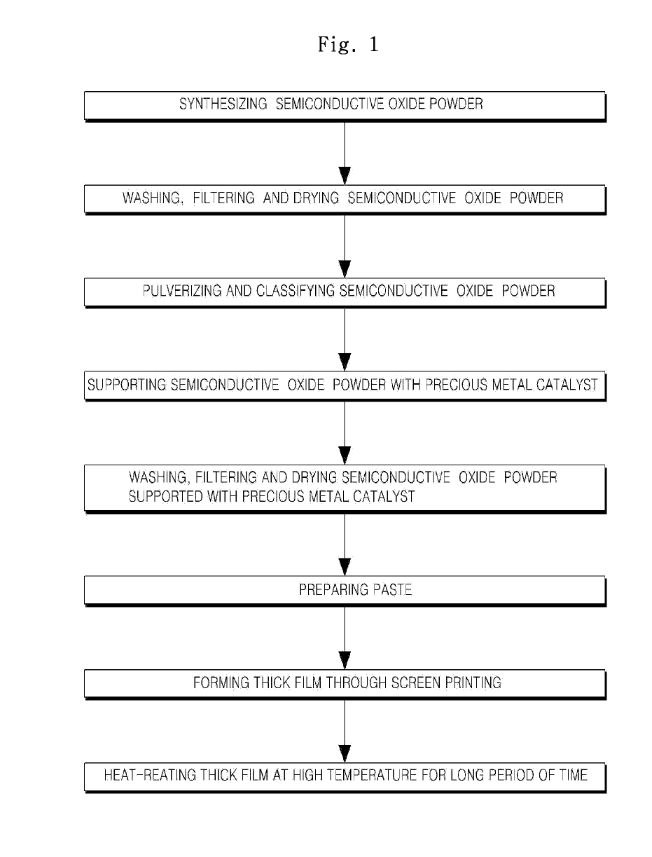

FIG. 2 is a view for explaining a principle of a SnO₂ gas sensor;

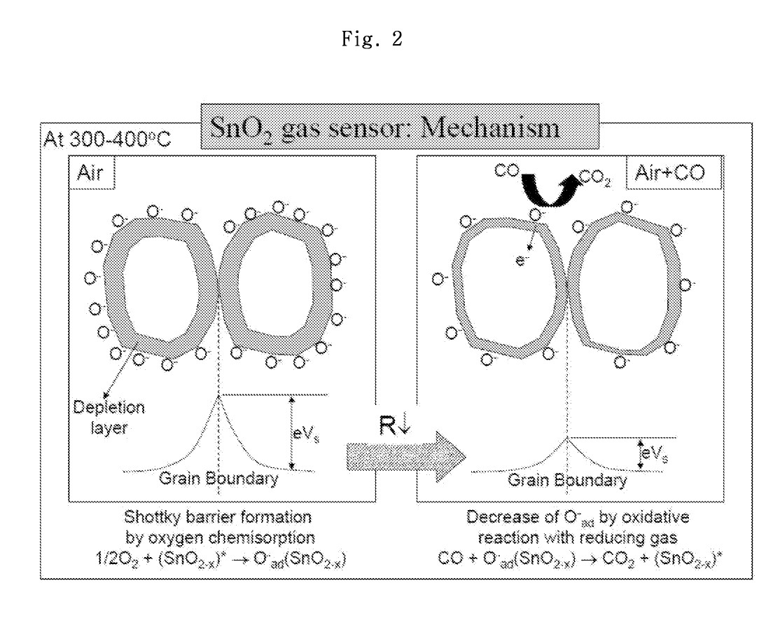

FIG. 3 is a view showing the change in resistance of a gas sensor according to the particle size of SnO₂;

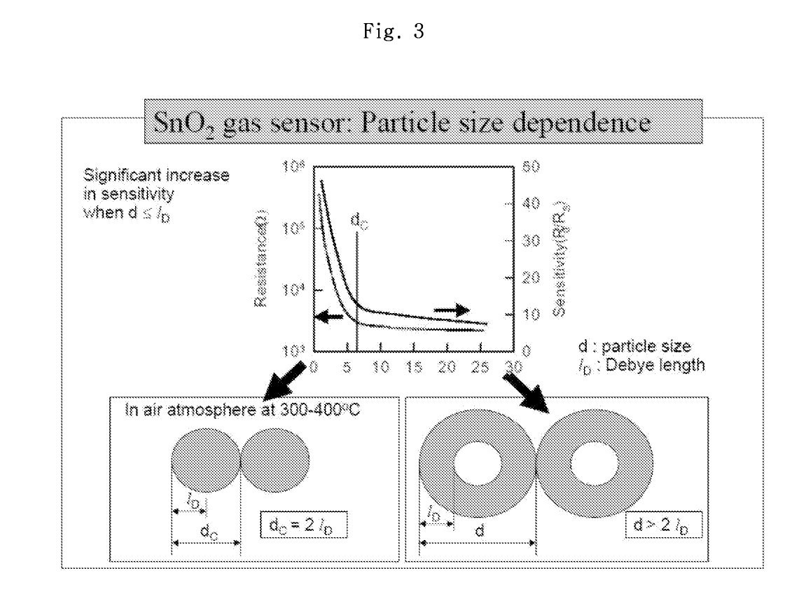

FIG. 4 is a schematic view showing a core-shell structured metal-metaloxide composite nanoparticle;

FIG. 5 is a transmission electron microscope (TEM) photograph showing core-shell structured Au—SnO₂ composite nanoparticles;

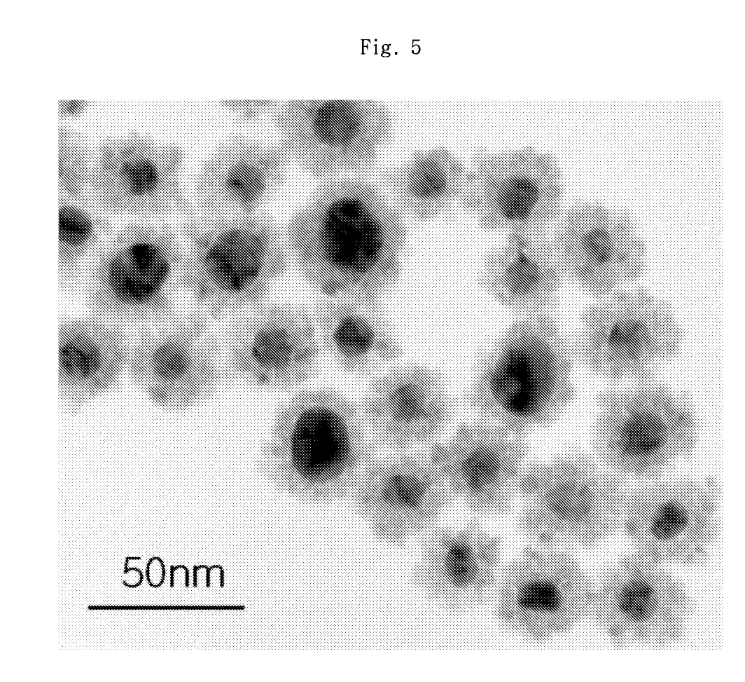

FIG. 6 is a transmission electron microscope (TEM) photograph showing core-shell structured Au—TiO₂ composite nanoparticles;

FIG. 7 is a graph showing the test results of thermal stability of core-shell structured Au—SnO₂ composite nanoparticles;

FIG. 8 is a graph showing the test results of thermal stability of core-shell structured Au—TiO₂ composite nanoparticles;

FIG. 9 is a photograph showing an electrode circuit substrate provided thereon with a core-shell structured Au—SnO₂ composite nanoparticle thin film;

FIG. 10 is a graph showing CO sensing properties of an Au—SnO₂ composite nanoparticle gas sensor at 300° C.;

FIG. 11 is a graph showing CO sensing properties of an Au—SnO₂ composite nanoparticle gas sensor at 250° C.;

FIG. 12 is a graph showing CO sensing properties of an Au—SnO₂ composite nanoparticle gas sensor at 200° C.; and

FIG. 13 is a graph showing electrical resistance stabilization time of an Au—SnO2 composite nanoparticle gas sensor at 250° C.

### BEST MODE

Hereinafter, a thin-film high-activity gas sensor using core-shell structured composite nanoparticles according to the present invention and a method of manufacturing the same will be described in detail with reference to the accompanying drawings.

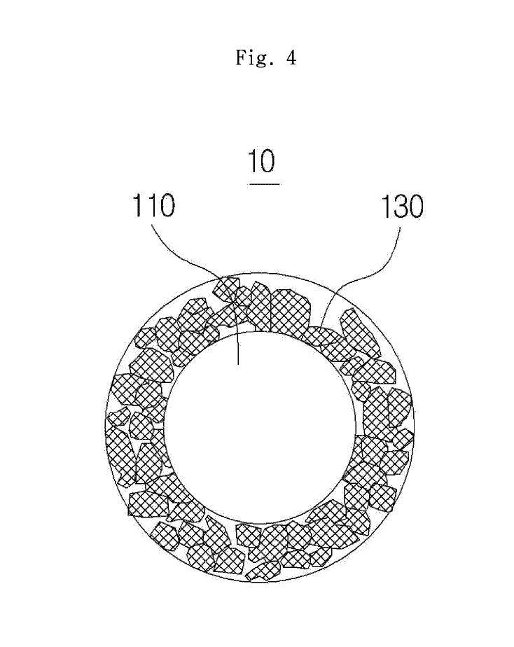

FIG. 4 is a schematic view showing a core-shell structured metal-metaloxide composite nanoparticle.

A thin-film high-activity gas sensor according to the present invention is manufactured by applying core-shell structured composite nanoparticles 10 onto an electrode circuit substrate to form a thin film and then heat-treating the thin film.

As shown in FIG. 4, each of the core-shell structured composite nanoparticles 10 includes a core 110 which is made of metal nanoparticles and a shell 130 which is made of metal oxide nanoparticles and covers the metal nanoparticle core 110.

The core 110 may be made of metal nanoparticles having excellent electroconductivity and antioxidant properties, such as Au, Ag, Pt, Pd, Ir, Rh nanoparticles or the like, in order to allow electrons to easily transfer and thus to improve the sensitivity of a gas sensor.

The shell 130 may be configured such that metal oxide nanoparticles are formed into a single layer on the core 110 or such that metal oxide nanoparticles are directly formed into the shell on the core 110. The shell 130 may be made of semiconductive metal oxide nanoparticles such as TiO₂, SnO₂, ZnO, ZrO₂, WO₃, In₂O₃, V₂O₅ and RuO nanoparticles or the like.

The core-shell structured composite nanoparticles may be manufactured by conventional nanoparticle manufacturing methods such as a precipitation method, a sol-gel method, a hydrothermal synthesis method and the like.

Since the semiconductive metal oxide nanoparticles constituting the shell 130 of each of the core-shell structured composite nanoparticles are formed on the core by heterogeneous nucleation, semiconductive metal oxide nanoparticles having a particle size of 1˜several tens of nm and having large specific surface area can be prepared, and the growth of the semiconductive metal oxide nanoparticles constituting the shell 130 is greatly inhibited during high-temperature heat treatment.

As such, since the particle size of the semiconductive metal oxide nanoparticle is very small and the specific surface area thereof is large, the sensitivity of a gas sensor is greatly improved, so that a precious metal catalyst, such as a platinum catalyst, need not be added in order to improve the sensitivity thereof.

The improvement in sensitivity of a gas sensor according to the present invention will be compared with that of a conventional gas sensor as follows. The improvement of sensitivity of a gas sensor according to the present invention can be accomplished due to the increase in the amount of adsorbed gas and the increase in the ratio of electron depletion layers in a sensing material, which is caused by forming the sensing material into nanoparticles and thus enlarging the specific surface area of the semiconductive metal oxides. In contrast, since the improvement in sensitivity of the conventional gas sensor is accomplished due to the increase in ionization or decomposition rate of reaction gas, which is caused by the addition of a precious metal catalyst such as a platinum catalyst, there is a problem in that the selectivity of the gas sensor to a gas is deteriorated because the sensitivity of the gas sensor to all kinds of gases is improved. Therefore, the gas sensor according to the present invention is very advantageous in that the sensitivity of the gas sensor can be improved without deteriorating the selectivity of the gas sensor to gas because the sensitivity of the gas sensor is improved by physical effects, such as the increase in the surface area of the sensing material, the increase in the ratio of electron depletion layers in the sensing material and the like, instead of chemical effects attributable to the conventional gas sensor.

A composite nanoparticle concentrated colloid solution, which is prepared by redispersing the core-shell structured composite nanoparticles in a pure solution, is applied onto an electrode circuit substrate through a drop coating method, a dip coating method, a spin coating method or an ink jet printing method, thus forming a sensing material thin film on the electrode circuit substrate. The sensing material thin film may be heat-treated in order to obtain sufficient adhesion force.

As described above, according to a method of manufacturing the thin-film high-activity gas sensor of the present invention, its manufacturing process can be simplified because metal oxide is not required to be pulverized, classified and made into paste, thus greatly improving productivity.

Further, since the core-shell structured composite nanoparticles are formed into a thin film on an electrode circuit substrate in a highly-concentrated colloidal state, a high-temperature sintering process is not required, and sufficient adhesion force can be imparted to the thin film through a low-temperature sintering process of 400˜500° C.

SnO₂ is generally sintered at a temperature of 700˜800° C. However, since the adhesion force between the sintered SnO₂ and electrode circuit substrate is low, SnO₂ fine powder is used as a sintering agent. However, in the present invention, sufficient adhesion force can be obtained through a heat treatment process of 400˜500° C., and the sensitivity of a gas sensor is not deteriorated by the addition of a nonconductive sintering agent such as SiO₂.

Further, since the gas sensor of the present invention is operated using a small amount of semiconductive metal oxide nanoparticles, the stabilization time of the gas sensor can be shortened at the time of initial operation. A conventional gas sensor using commercially available SnO₂ requires a stabilization time of 24˜48 hours, but the gas sensor of the present invention requires a stabilization time of 10 hours or less, which is advantageous.

Furthermore, in the conventional technologies, it is really difficult to form a gas sensing material into nanoparticles. The reason for this is that, when heat treatment temperature is increased in order to increase the crystallinity of a semiconductive metal oxide required to improve the sensing properties thereof, grain growth simultaneously occurs, so that the specific surface area thereof is decreased, with the result that the sensitivity of the gas sensing material is deteriorated. In conclusion, the heat treatment of the semiconductive metal oxide must be performed under the condition that the grain growth thereof does not occur.

However, according to the core-shell structured composite nanoparticles of the present invention, a gas sensing material can be really formed into nanoparticles, and the heat treatment thereof can be performed at high temperature without grain growth.

### MODE FOR INVENTION

Hereinafter, the present invention will be described in more detail with reference to the following Examples. However, the scope of the present invention is not limited thereto.

### Example 1

### Synthesis of Au—SnO₂ Composite Nanoparticles

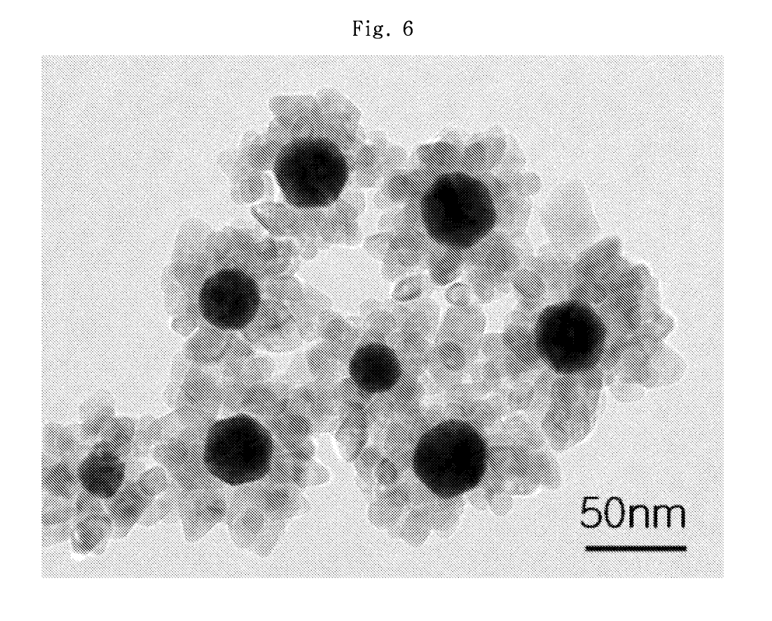

First, 0.1 g of HAuCl₄ was dissolved in 500 mL of ultrapure water and then heated to the boiling point. Then, 100 mL of ultrapure water in which 1 g of tri-sodium citrate was dissolved as a reductant was added thereto to prepare an Au nanoparticle colloid solution having a particle size of 12˜15 nm. Subsequently, 20 mL of this reaction solution was adjusted to a pH of 11, and then 1 mL of an aqueous Na₂SnO₃ solution (40 mM) was added thereto, and then the mixed solution was reacted at 60° C. for 2 hours to synthesize Au—SnO₂ composite nanoparticles. The TEM photograph thereof is shown in FIG. 6.

### Example 2

### Synthesis of Au—TiO₂ Composite Nanoparticles

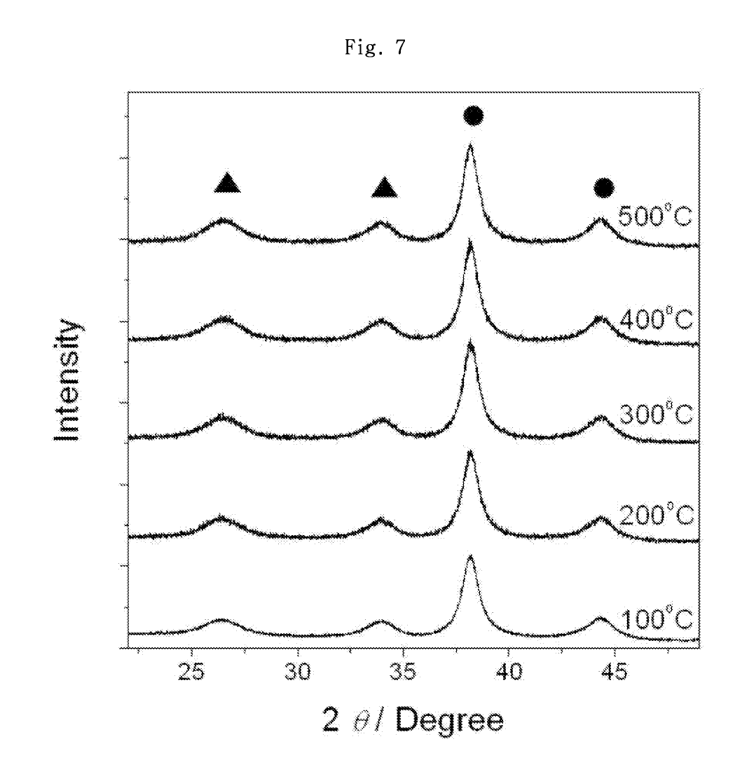

Titanium isopropoxide (a titanium alkoxide) and triethanolamine, serving as a complexing agent, were mixed at a mixing ratio of 1:2, and then this mixed solution was mixed with ultrapure water such that the concentration of titanium ions in the mixed solution was 0.01 mM, so as to prepare a diluted titanium alkoxide complex salt solution. Subsequently, 100 mL of this reaction solution was mixed with 3.3 mL of the Au nanoparticle colloid solution prepared in Example 1, and then the mixed solution was put into an autoclave and then hydrothermally synthesized at a temperature of 80° C. for 24 hours to synthesize Au—TiO₂ composite nanoparticles. The TEM photograph thereof is shown in FIG. 7.

[Thermal Stability Test]

The thermal stability of the Au—SnO₂ composite nanoparticles of Example 1 was evaluated by observing the change in crystal structure of SnO₂ constituting the shell of the Au—SnO₂ composite nanoparticles through X-ray diffraction analysis after heat-treating the Au—SnO₂ composite nanoparticles at a temperature of 100˜500° C. for 2 hours. The results thereof are shown in FIG. 7. In FIG. 7, ▴ is SnO₂ (Cassiterite), and is Au.

Here, SnO₂ shows the crystal structure of cassiterite. Further, the grain size of the sample heat-treated at 100° C. is 6 nm, and the grain size of the sample heat-treated at 500° C. is 7 nm, so that it can be seen that the grain growth of SnO₂ is extremely limited.

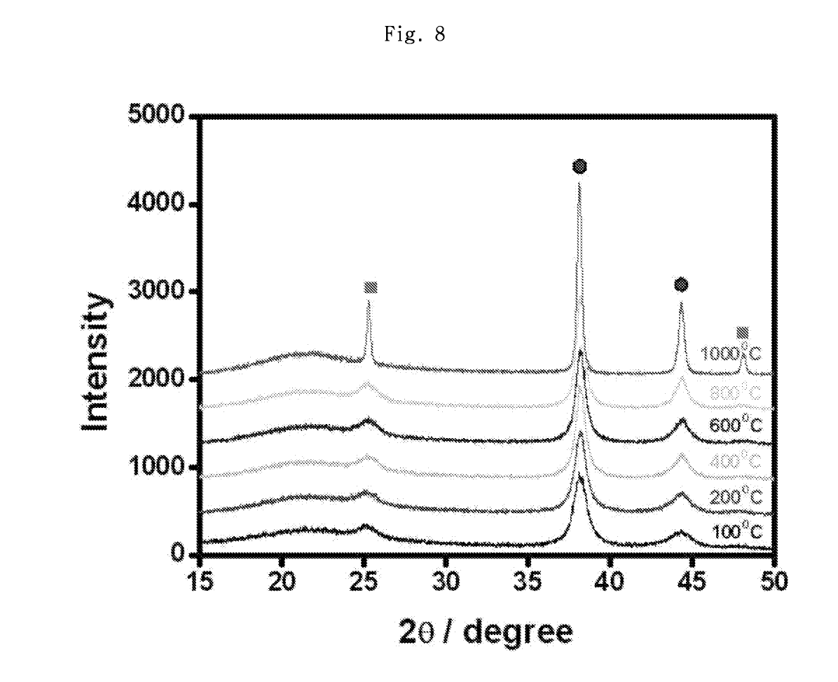

The thermal stability of the Au—TiO₂ composite nanoparticles of Example 2 was evaluated by observing the changes in the crystal structure and particle size of TiO₂ constituting the shell of the Ti—SnO₂ composite nanoparticles through X-ray diffraction analysis after heat-treating the Ti—SnO₂ composite nanoparticles at a temperature of 100˜1000° C. for 2 hours. The results thereof are shown in FIG. 8. In FIG. 8, ▪ is TiO₂ (Cassiterite), and is Au.

Through X-ray diffraction analysis, it can be seen that the crystal structure of TiO₂ constituting the shell of the Ti—SnO₂ composite nanoparticles is an anatase crystal structure. Generally, the crystal structure of TiO₂, which is the anatase crystal structure, is converted into a rutile crystal structure at a temperature of 600˜700° C. together with grain growth. However, from the result of the X-ray diffraction analysis, it can be seen that the crystal structure of TiO₂ remains as the anatase crystal structure because the grain growth in the Ti—SnO₂ composite nanoparticles is very limited even at high temperature. The grain size of SnO₂ was calculated by Scherrer's Equation from the results of X-ray diffraction analysis. The grain size of TiO₂ heat-treated at 100° C. for 2 hours was 8 nm, and the grain size of TiO₂ heat-treated at 800° C. for 2 hours is 10 nm, so that it was found that the grain growth of TiO₂ hardly occurred.

### Example 3

### Manufacture of an Electrode Circuit Substrate

The Au—SnO₂ composite nanoparticles synthesized in Example 1 were separated using a centrifugal machine at a rotation speed of 15000 rpm, and were then redispersed in ultrapure water such that the amount of Au—SnO₂ is 1 wt % to obtain an Au—SnO₂ composite nanoparticle concentrated colloid solution.

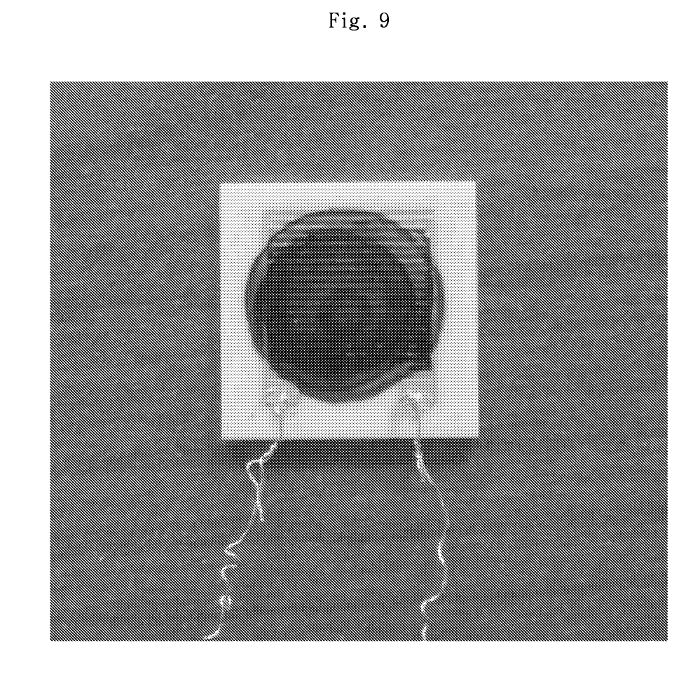

50 μl of the Au—SnO₂ composite nanoparticle concentrated colloid solution was dropped onto an alumina substrate using a micropipette and then dried to form a sensing material thin film. Subsequently, the sensing material thin film was heat-treated at 350° C. for 3 hours to manufacture an electrode circuit substrate provided thereon with a core-shell structured Au—SnO₂ composite nanoparticle thin film, as shown in FIG. 9.

[Examination of CO Sensing Properties]

(1) CO Sensing Properties at 300° C.

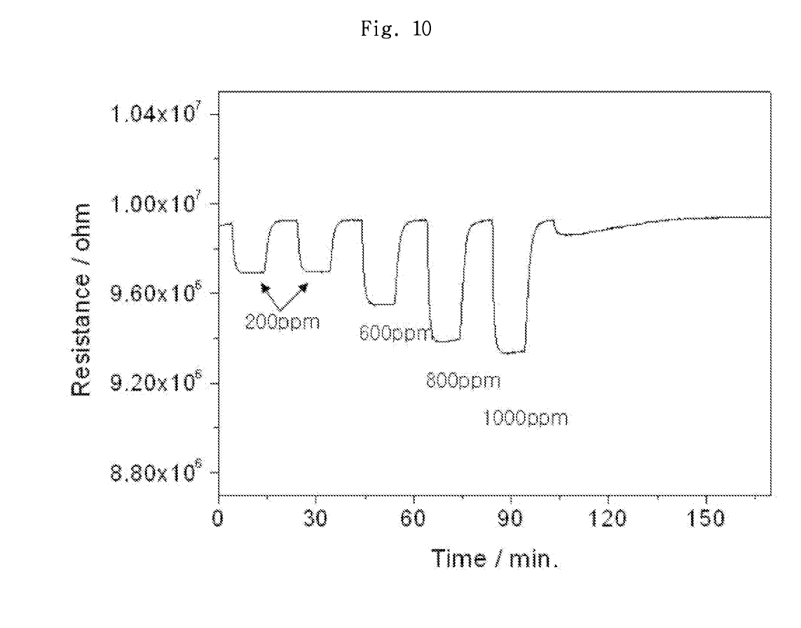

CO sensing properties in a CO concentration range of 200˜1000 ppm at a temperature of 300° C. were examined using the electrode circuit substrate provided thereon with a core-shell structured Au—SnO₂ composite nanoparticle thin film, manufactured in Example 3. During the examination, O₂ was adjusted to have a concentration of 21%, and the resistance change due to the CO gas implantation was measured at 10-minute intervals to evaluate the CO sensing properties, and the results thereof are shown in FIG. 10.

From FIG. 10, it can be seen that the resistance was greatly decreased due to the CO gas implantation, and the reduction rate of resistance was increased depending on the increase in concentration of CO gas. Therefore, it can be seen that the core-shell structured Au—SnO₂ composite nanoparticles reacted with CO gas in high sensitivity.

(2) CO Sensing Properties at 250° C.

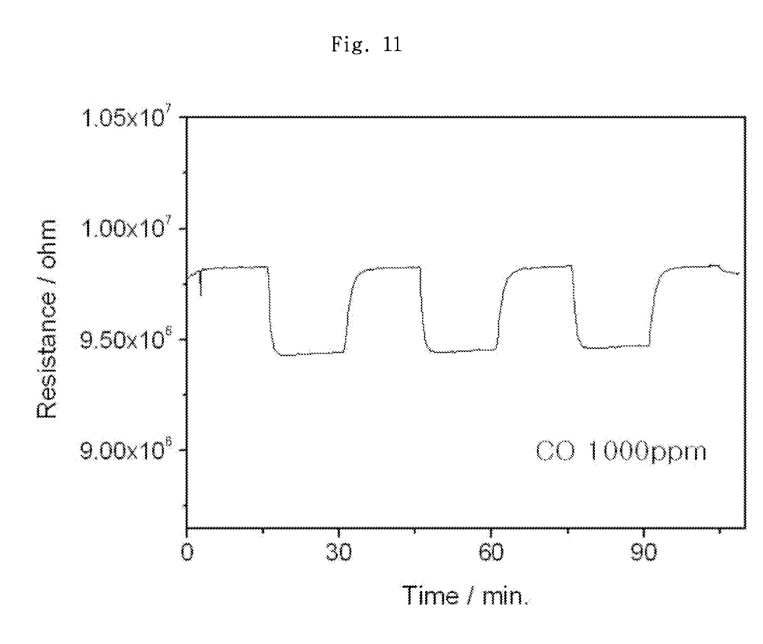

CO sensing properties in a CO concentration of 1000 ppm at a temperature of 250° C. were examined three times at 15-minutes intervals using the electrode circuit substrate provided thereon with a core-shell structured Au—SnO₂ composite nanoparticle thin film, manufactured in Example 3. The results thereof are shown in FIG. 11. From FIG. 11, it can be seen that the base lines of sensing signals at the temperature are constant, and the repeatability of the gas sensing reaction is very excellent.

(3) CO Sensing Properties at 200° C.

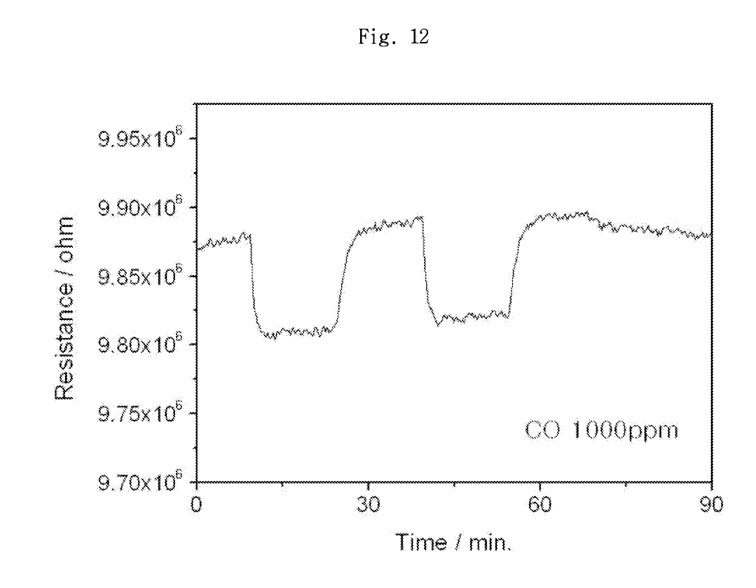

CO sensing properties in a CO concentration of 1000 ppm at a temperature of 200° C. were examined two times at 15-minutes intervals using the electrode circuit substrate provided thereon with a core-shell structured Au—SnO₂ composite nanoparticle thin film, manufactured in Example 3. The results thereof are shown in FIG. 12.

[Stabilization Time Test]

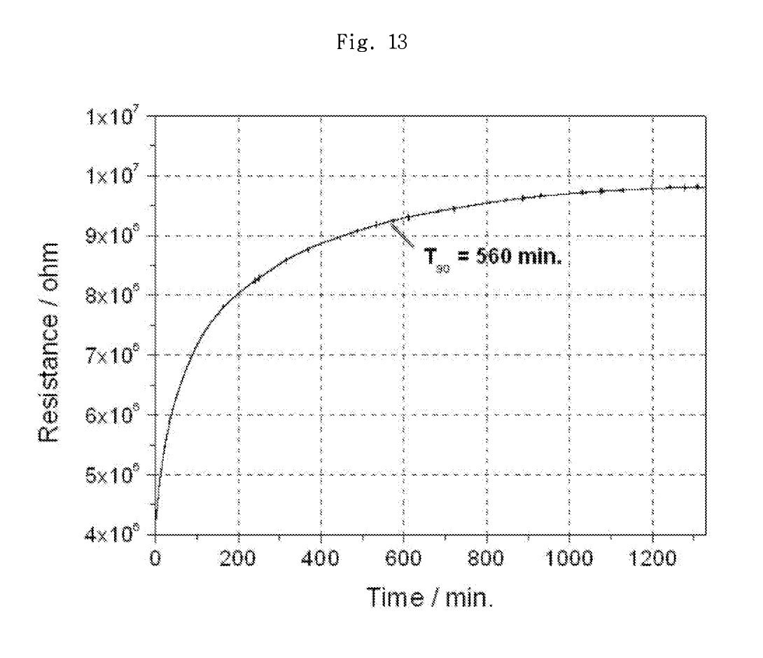

The stabilization time of a sensor electrode including the core-shell structured Au—SnO₂ composite nanoparticle thin film to resistance change was tested at 250° C. The sensor electrode was put in an electric furnace at 250° C., and then the resistance change thereof was measured for 24 hours without introducing gas. The results thereof are shown in FIG. 13.

Generally, the resistance of a semiconductive gas sensing material at an initial operation is not constant, and is continuously changed depending on the kind of sensing material used for the semiconductive gas, and is then stabilized after 24˜48 hours. The “stabilization time” of the semiconductive gas sensing material is defined as the time (T90%) taken for the resistance thereof to reach 90% of the final resistance thereof. In the case of Au—SnO₂ composite nanoparticles, its stabilization time (T90%) is 560 minutes, so that it can be seen that the Au—SnO₂ composite nanoparticles are stabilized within 10 hours.

### INDUSTRIAL APPLICABILITY

According to the thin-film high-activity gas sensor of the present invention, a sensing material can be really formed into nanoparticles, the sensitivity, selectivity and long-term stability of the gas sensor can be greatly improved, the manufacturing process thereof is simplified to greatly improve the productivity thereof, and it can be formed into a thin film and be miniaturized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A thin-film high-activity gas sensor using a core-shell structured composite nanoparticle as a sensing material, the composite nanoparticle comprising a core and a shell covering the core.

2. The thin-film high-activity gas sensor according to claim 1, wherein the core is made of metal nanoparticles having excellent electroconductivity and antioxidant properties.

3. The thin-film high-activity gas sensor according to claim 1, wherein the shell is made of metal oxide nanoparticles having semiconductivity.

4. A method of manufacturing a thin-film high-activity gas sensor, comprising:
applying a composite nanoparticle including a metal nanoparticle core and a metal oxide nanoparticle shell covering the metal nanoparticle core onto an electrode circuit substrate.

5. The method manufacturing a thin-film high-activity gas sensor according to claim 4, wherein the composite nanoparticle is applied onto the electrode circuit substrate using any one selected from among a drop coating method, a dip coating method, a spin coating method and an ink-jet printing method to form a thin film.
